(19) United States
(12) Patent Application Publication
(10) Pub. No.: US 2012/0271561 A1
(43) Pub. Date: Oct. 25, 2012

(54) SYSTEM AND METHOD FOR AIRCRAFT POLLUTION ACCOUNTABILITY AND COMPLIANCE TRACKING

(76) Inventors: Andrew Keller-Goralczyk, Chantilly, VA (US); Joshua Finks, Great Falls, VA (US); Omar Mathir, Ashburn, VA (US); David Helmly, Fredericksburg, VA (US); Abdulrahman Althagafi, Fairfax, VA (US)

(21) Appl. No.: 13/452,858

(22) Filed: Apr. 21, 2012

Related U.S. Application Data
(60) Provisional application No. 61/478,473, filed on Apr. 22, 2011.

(51) Int. Cl. G06F 19/00

(52) U.S. Cl. 702/24

(57) ABSTRACT

A system method, and computer program product for individual aircraft pollution tracking, including at least one of real-time pollution tracking and pollution estimation of individual moving aircraft, wherein the pollution estimation is equal in accuracy as relative accuracy of employed inputs; pollution estimation for various aircraft, and various types of pollution based on suitably available raw data; and pollution estimation including filtering of outputs and formatting thereof to provide usability for comparison to regulation criteria and assessments of pollution mitigation efforts, including fleet mix, level of technology, and pollution attainment determination.

### CROSS REFERENCE TO RELATED DOCUMENTS

The present invention is related to U.S. Provisional Patent Application Ser. No. 61/478,473 of GORALCZYK et al., entitled “SYSTEM AND METHOD FOR AIRCRAFT POLLUTION ACCOUNTABILITY AND COMPLIANCE TRACKING,” filed on Apr. 21, 2011, the entire disclosure of which is hereby incorporated by reference herein.

### BACKGROUND OF THE INVENTION

1. Field of the Invention

The present invention generally relates to pollution monitoring, and more particularly to a method and system for individual aircraft pollution tracking and the like.

2. Discussion of the Background

Aircraft produce emissions and pollution harmful to humans and the environment. Though aircraft are only responsible for a small percentage of transportation industry emissions, higher concentrations of air traffic at lower altitudes around major airports cause increased local pollution levels. In addition, current pollution monitoring systems generally provide only an area-wide sample of the local air quality based on aircraft output. Accordingly, there exists a need for a system and method to ensure individual tracking of pollution and emissions for vehicles, such as aircraft, and the like, at various locations, such as major airports, and the like, for the purpose of regulation.

### SUMMARY OF THE INVENTION

Therefore, there exists a need for a method and system that addresses the above and other problems. The above and other problems are addressed by the illustrative embodiments of the present invention, which provide methods and systems that generate a cumulative output estimate of various pollution production levels, including, for example, any suitable existing, theoretical, and the like, regulation criteria. The systems and methods allow for input of compliance standards, which are compared to calculated emissions estimates. Such cumulative emissions estimate is computed, for example, by referencing standardized pollutant index databases, collected flight track data, an aircraft's unique identification number, and the like, referred to as an Emissions Inventory (EI). Advantageously, the illustrative methods and systems provide a level of accuracy that enables comprehensive assessment to be performed for each individual aircraft, and the like.

Accordingly, in illustrative aspects of the present invention there is provided a system, method, and computer program product for air pollution accountability and compliance tracking, including at least one of real-time pollution tracking and pollution estimation of individual moving aircraft, wherein the pollution estimation is equal in accuracy as relative accuracy of employed inputs; pollution estimation for various aircraft, and various types of pollution based on suitably available raw data; and pollution estimation including filtering of outputs and formatting thereof to provide usability for comparison to regulation criteria and assessments of pollution mitigation efforts, including fleet mix, level of technology, and pollution attainment determination.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative diagram (e.g., an Integration Definition for Function Modeling (IDEF-0 diagram) of the inventive method and system functionality for producing generated results, including interfacing with information stores, and performing a pollution estimation;

FIG. 2 is an illustrative functional flow block diagram of system and method functionality to perform pollution estimation in the system of FIG. 1;

FIG. 3 is an illustrative diagram (e.g., an IDEF-0 diagram) of a pollution estimation sub-function of the system and method of FIG. 1, including functions performed during pollution estimation, employed inputs, intermediate data sets, and produced outputs;

FIG. 4 is an illustrative functional flow-block diagram of a pollution estimation sub-function of the systems and methods of FIGS. 1-3, including a pollution estimation algorithm; and

FIG. 5 is an illustrative overall system that can employ the illustrative systems and methods of FIGS. 1-4.

### DETAILED DESCRIPTION OF THE PREFERRED EMBODIMENTS

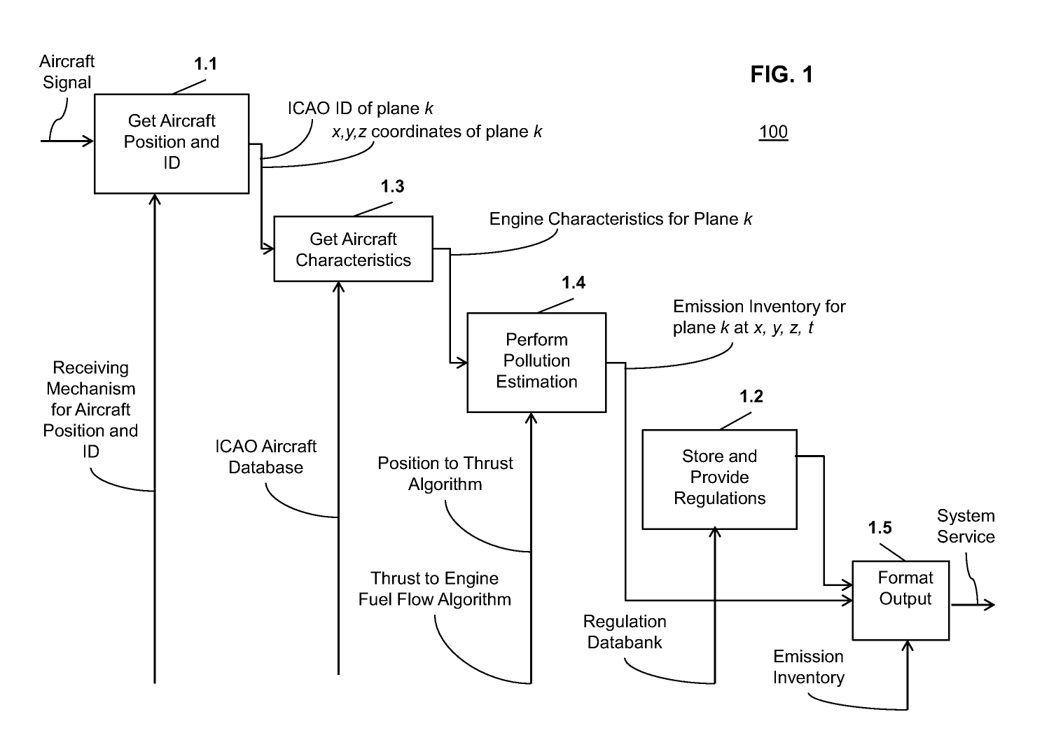

Referring now to the drawings, wherein like reference numerals designate identical or corresponding parts throughout the several views, and more particularly to FIGS. 1-5 thereof, there are illustrated the systems and methods for performing pollution estimation and which can be referred to as an aircraft pollution accountability and compliance (A-PACT) system.

In FIG. 1, the system 100 can include sub-systems 1.1 and 1.3 that exemplify the retrieval of track data from each aircraft by, for example, global positioning systems (GPS), radar multilateration systems, airport surface detection equipment, model X (ASDE-X) systems, and the like. The estimate pollution sub-system 1.4 accepts such inputs from sub-systems 1.1 and 1.3. The system 100 also receives information such as the aircraft's unique identification number, and the like, for example, from scheduling information via flight roster, automatic dependent surveillance-broadcast (ADS-B) information, and the like. Such information can be provided by the sub-system 1.1. The system 100 accepts inputs regarding the engine characteristics based on the aircraft's unique ID by means of engine databanks or any other suitable sources, such verified published databases, and the like. Such information can be provided by the sub-system 1.3. Such database and/or compilation of databases can include information, such as maximum thrust output of the engine, fuel consumption rates at various thrust levels, and the like. The system 100 can accept inputs from a database/compilation of databases which provide(s) information regarding emissions output, such as the mass of pollution produced per mass of fuel burned, and the like. The resulting unit of measurement is referred to as the emissions inventory (EI) and can be used as a metric of pollutant mass for the purposes of regulations, study, and the like. In an illustrative embodiment, such value can be compared to existing regulation criteria to determine attainment status, and the like.

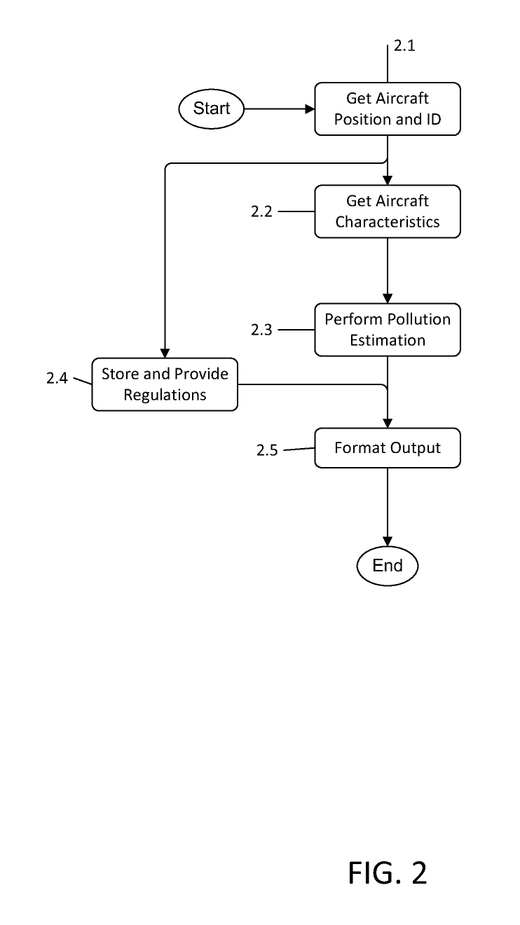

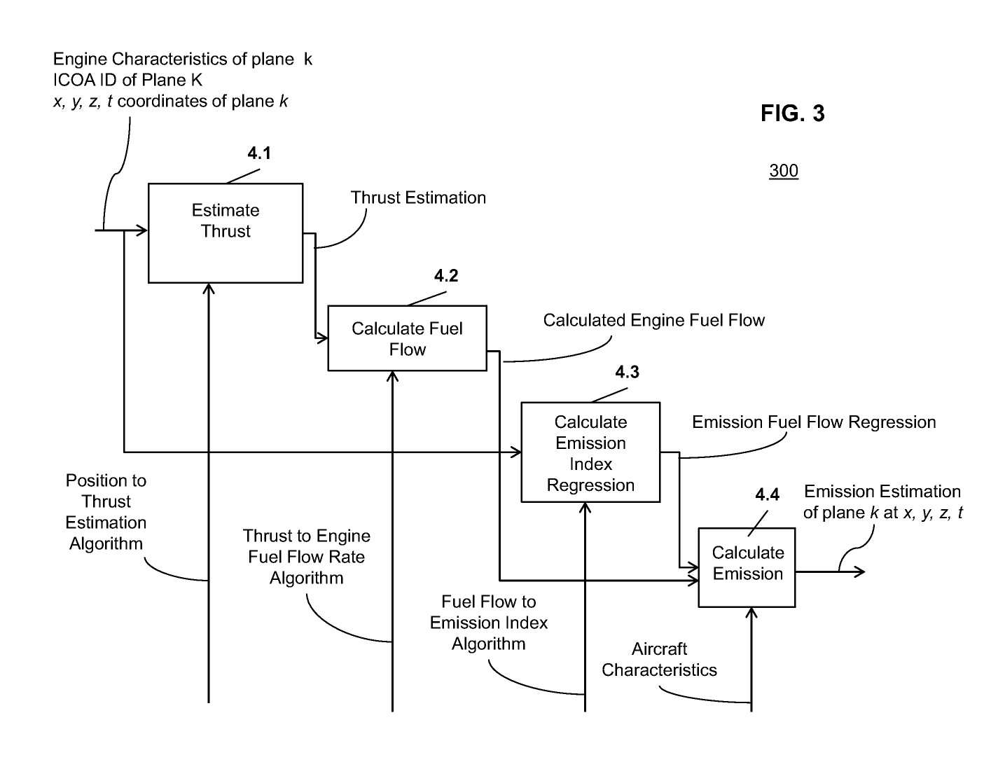

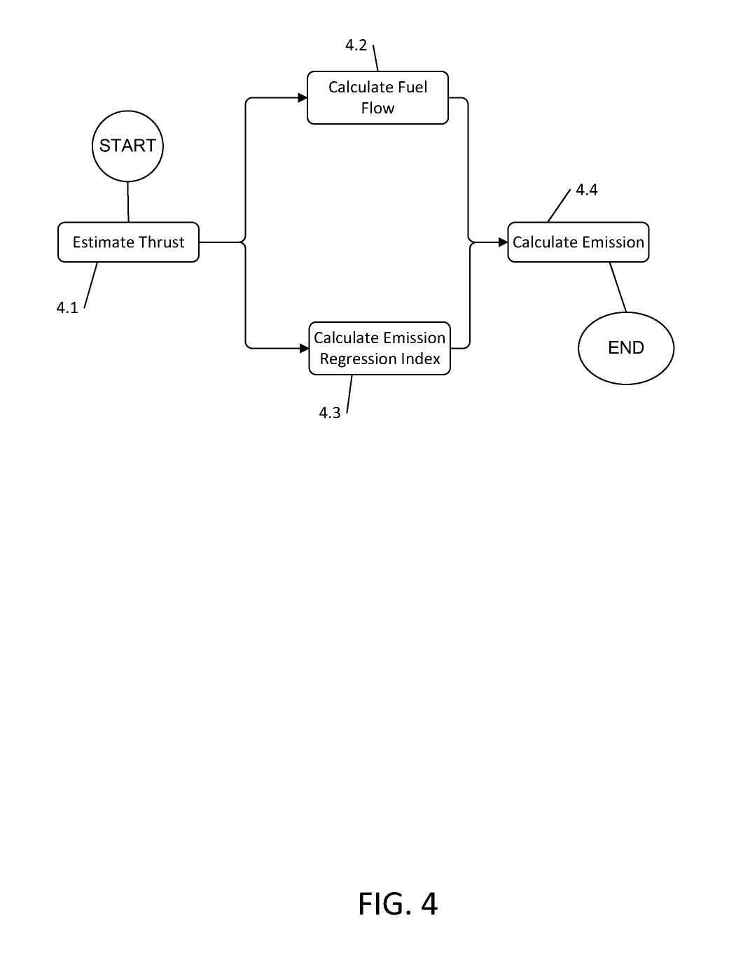

FIG. 2 is an illustrative functional flow block diagram 200 of the system and method functionality to perform pollution estimation 1.4 in the system 100 of FIG. 1. FIGS. 3 and 4 are illustrative sub-systems 300 and 400, respectively, of the sub-system 1.4 (estimate pollution) of the system 100 FIG. 1.

In FIGS. 3-4, when each of the thrust values are calculated (e.g., by sub-systems 3.1, 4.1), the information which are functions of thrust are determined and for example, include fuel flow (ff), and emission index (ei). Such calculated data is input into sub-systems 3.4, 4.4 (calculate emissions), which is then formed into an output.

Fuel flow (e.g., given in kg/s), and emission index (e.g., given in g/kg), when multiplied, result in emission flow rate (e.g., given in g/s). When such result is multiplied by the time interval for the respective thrust value, this results in a total EI for that segment of the flight. Such calculations are performed, for example, for each flight segment where a different thrust level is reached, for all pollutants, and for each flight processed by the A-PACT system, and the like.

Illustrated are the inner workings of estimate emissions (e.g., sub-system 1.4), wherein thrust levels are retrieved from sub-system 4.1, information can be obtained from such thrust values, such as fuel flow, ff (e.g., sub-system 4.2) and emission index, ei (e.g., sub-system 4.3) and which can be calculated using thrust regression equations, and the like. The ff and ei are input into sub-system 4.4 (calculate emissions) and the total EI for such data set is an output.

The total emissions output of each aircraft can be calculated and given, for example, by the following equation:

EI=(ff*ei*t*ce),

where E.I. is the total Emissions Inventory of a particular aircraft measured in mass of pollutants; ff is the fuel flow of the engine; ei is the emission-index for a specific pollutant; t is the time interval for each level of thrust; and ce is the total number of engines. Fuel flow is a function of thrust and is given in mass of fuel burned per unit of time for each engine. Emission-index is a function of fuel flow and is given in mass of pollutant produced per mass of fuel burned. Such values are summated for all thrust levels during each segment of the flight.

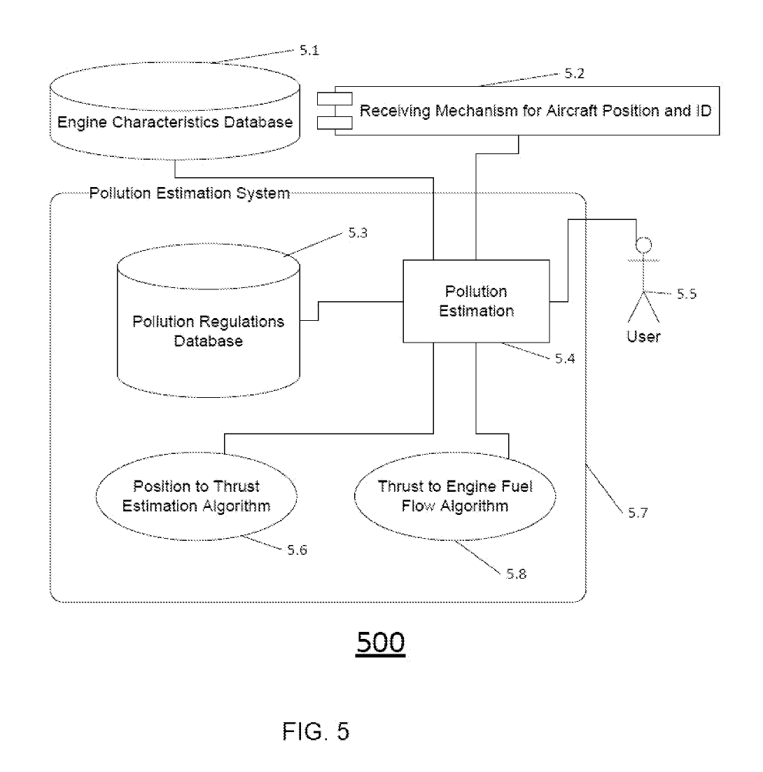

FIG. 5 is an illustrative overall system 500 that can employ the illustrative systems and methods of FIGS. 1-4. The illustrative output of the A-PACT system 500 can generate the total emissions inventory for the pollutant types during each flight segment, as well as the total output for the entire flight segment data, and the like.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the described devices and subsystems are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Although the systems and methods of FIGS. 1-5 are described in terms of being employed for aircraft pollution accountability, compliance tracking, and the like, the systems and methods of FIGS. 1-5 can be employed with other types of vehicles, such as boats, trucks, trains, and the like, by employing the teachings of the present invention, as will be appreciated by those of ordinary skill in the relevant art(s).

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for individual aircraft pollution tracking, comprising:
one or more computer devices configured for real-time pollution tracking and pollution estimation of individual moving aircraft, wherein the pollution estimation is equal in accuracy as relative accuracy of employed inputs;
the computer devices for pollution estimation configured for a plurality of aircraft, and a plurality of types of pollution based on raw data; and
the computer devices configured for filtering of outputs and formatting thereof to provide usability for comparison to regulation criteria and assessments of pollution mitigation efforts, including fleet mix, level of technology, and pollution attainment determination.

2. A computer implemented method for individual aircraft pollution tracking, comprising:
real-time pollution tracking and pollution estimating of individual moving aircraft by one or more computer devices, wherein the pollution estimation is equal in accuracy as relative accuracy of employed inputs;
estimating pollution by the one or more computer devices for a plurality of aircraft, and a plurality of types of pollution based on raw data; and
filtering of outputs and formatting thereof by the computer devices to provide usability for comparison to regulation criteria and assessments of pollution mitigation efforts, including fleet mix, level of technology, and pollution attainment determination.

3. A computer program product for individual aircraft pollution tracking including one or more non-transitory computer readable instructions configured to cause one or more computer processors to perform one or more of the steps of:
real-time pollution tracking and pollution estimating of individual moving aircraft by one or more computer devices, wherein the pollution estimation is equal in accuracy as relative accuracy of employed inputs;
estimating pollution by the one or more computer devices for a plurality of aircraft, and a plurality of types of pollution based on raw data; and
filtering of outputs and formatting thereof by the computer devices to provide usability for comparison to regulation criteria and assessments of pollution mitigation efforts, including fleet mix, level of technology, and pollution attainment determination.
